(19) United States
(12) Patent Application Publication
(10) Pub. No.: US 2003/0098350 A1
(43) Pub. Date: May 29, 2003

(54) Counterfeit money detecting barcode scanner

(76) Inventors: Kenneth Liou, Taipei Hsien (TW); Chih-Chien Lin, Taipei Hsien (TW)

Correspondence Address: RABIN & BERDO, P.C., Suite 500, 1101 14th Street, N.W., Washington, DC, 20005, US

(21) Appl. No.: 10/151,027

(22) Filed: May 21, 2002

(30) Foreign Application Priority Data
Nov. 28, 2001 (TW) 90220578

(51) Int. Cl. G06K 7/10; G06K 9/22; G06K 19/06; G02B 26/10

(52) U.S. Cl. 235/462.25

(57) ABSTRACT

A counterfeit money detecting barcode scanner comprising a body with a scan light source, a lens and a CCD or CMOS image sensor inside. When the scan light source aims at and injects light beam to a barcode label, the reflected barcode label image is received and converted to digital signals by the CCD or CMOS image sensor; the digital signals will be stored or transmitted out for further usage. An ultraviolet light source is in the light injection or the reflected light direction; an independent switch can turn the ultraviolet light source on or off to detect counterfeit money.

### BACKGROUND OF THE INVENTION

I. Field of the Invention

This invention relates generally to a counterfeit money detecting barcode scanner and, more specifically, to a counterfeit money detecting barcode scanner used with a cash register, which not only can scan the barcode label on goods but also can check the paper money received at the same time.

II. Description of the Prior Art

Heretofore, it is known that counterfeit money exist, people accidentally poses counterfeit money will result in trouble and loss. Most of the real money has flourish fiber as one of the prevention methods, flourish fiber is very difficult to duplicate; therefore to have the ultraviolet light to identify counterfeit money if it has flourish fiber or not is the most convenient way. Most of the barcode scanners are just to read the reflected barcode label image. The cashiers are busy with scanning, taking money and giving the change back; it would be very difficult and inconvenient for cashiers to check the paper money one by one.

### SUMMARY OF THE INVENTION

It is therefore a primary object of the invention to provide a counterfeit money detecting barcode scanner that has an ultraviolet light source with an independent switch. Users can have not only the normal barcode scanning operation but also the counterfeit money detecting function.

In order to achieve the objective set forth, a counterfeit money detecting barcode scanner in accordance with the present invention comprises a body with a scanning light source, a lens and a CCD or CMOS image sensor inside. While the scanning light source scans a barcode label, the reflected image can be converted to digital signals by the image sensor, the image sensor also stores, transfers the digital signals to a cashier register or a computer through a cable. An ultraviolet light source located either in the direction injecting light source or reflecting light. The ultraviolet light source injects the ultraviolet beam directly to the front. While applying, users can press the identifying switch to inject the ultraviolet beam and identify whether the paper money is counterfeit or not.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the present invention;

FIG. 2 is a cross-sectional view of the present invention.

### DESCRIPTION OF THE PREFERRED EMBODIMENT

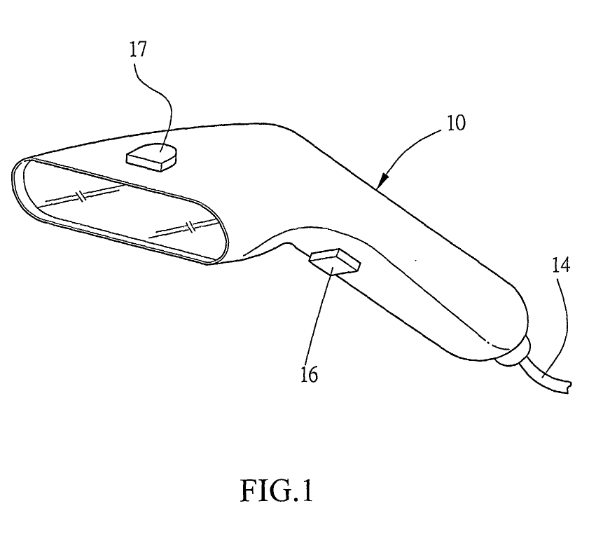

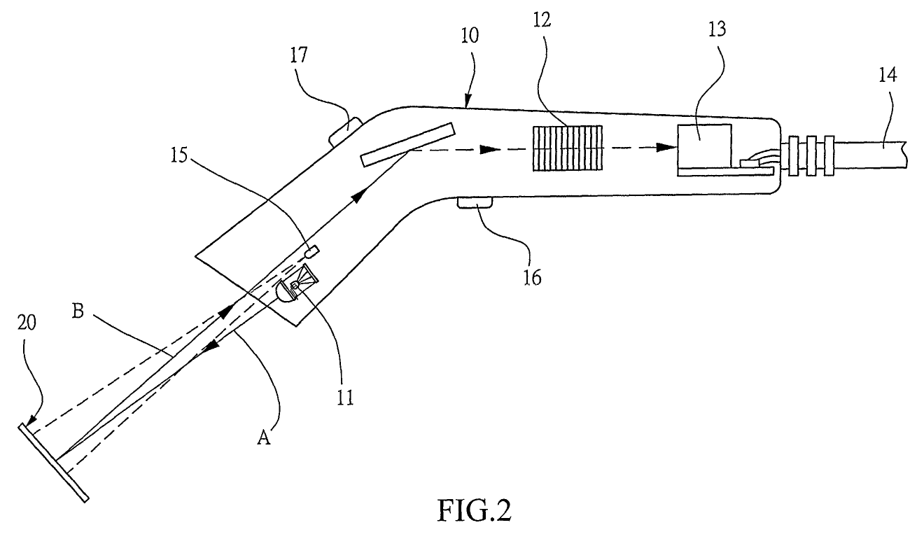

Referring to FIG. 1 and FIG. 2, the present invention is composed of a body 10 with a scanning light source 11, a lens 12 and a CCD or CMOS image sensor 13. While the scanning light source 11 scans a barcode label 20, the reflected image can be converted to digital signals by the image sensor 13, the image sensor 13 also stores, transfers the digital signals to a cashier register or a computer (not shown in FIG) through a cable 14.

Based on above structure, an ultraviolet light source 15 located either in the direction injecting light source A or reflecting light B. The ultraviolet light source 15 injects the ultraviolet beam directly to the front. A scanning switch 16 turns on and off the barcode scanning function. While applying the counterfeit money detecting function, users can press the identifying switch 17 to inject the ultraviolet beam and identify whether the paper money is counterfeit or not.

While a preferred embodiment of the invention has been shown and described in detail, it will be readily understood and appreciated that numerous omissions, changes and additions may be made without departing from the spirit and scope of the invention.

What is claimed is:

1. A counterfeit money detecting barcode scanner comprising:
a body with a scanning light source scanning a barcode label;
a lens;
a CCD or CMOS image sensor receiving and converting the reflected barcode image into digital signals;
a cable transferring digital signals to a cashier register or a computer;
an ultraviolet light source located either in the direction of injecting light source or reflecting light;
a scanning switch turning on and off the barcode scanning function;
an identifying switch turning said ultraviolet light source on or off;
wherein the improvement is characterized by said ultraviolet light source located either in the direction of injecting light source or reflecting light, said identifying switch turn on or off said ultraviolet light source to identify the counterfeit money.
